(19) United States
(12) Patent Application Publication
(10) Pub. No.: US 2023/0018247 A1
(43) Pub. Date: Jan. 19, 2023

(54) BRAIN-ACTIVITY ACTUATED EXTENDED-REALITY DEVICE

(71) Applicant: GOOGLE LLC, Mountain View, CA (US)

(72) Inventor: Rechavia Elias, Ashkelon (IL)

(21) Appl. No.: 17/812,809

(22) Filed: Jul. 15, 2022

Related U.S. Application Data
(60) Provisional application No. 63/203,269, filed on Jul. 15, 2021.

(51) Int. Cl. G06F 3/01; G06K 9/62; G06V 20/20; G06V 40/20

(52) U.S. Cl. CPC G06F 3/015; G06K 9/62; G06V 20/20; G06V 40/20; G06F 2203/011

(57) ABSTRACT

Quantum sensors may have a size suitable for integration with an extended reality device, such as an augmented reality device or a virtual reality device. When the extended reality device is worn on the head of a user, the quantum sensors can detect magnetoencephalography (MEG) signals from the user's brain. Trained computer models may be used in a recognition algorithm to detect and/or classify particular brain activities. The particular brain activities may then be used to control an extended reality application.

### CROSS-REFERENCE TO RELATED APPLICATION

This application claims the benefit of U.S. Provisional Application No. 63/203,269 filed on Jul. 15, 2021, which is hereby incorporated by reference in its entirety.

### FIELD OF THE DISCLOSURE

The present disclosure relates to extended reality and more specifically to an extended-reality device having one or more quantum sensors configured to sense a user's brain activity.

### BACKGROUND

Extended reality (XR) is a group of technologies that allow for digital information to interact with the senses of a user in a realistic way. XR devices can be configured to provide a user with additional information about a real environment (i.e., augmented reality (AR)), provide a user with a virtual environment (i.e., virtual reality (VR)), or some combination thereof (i.e., mixed reality (MR)). Accordingly, AR devices, VR devices, and MR devices may be generally referred to as XR devices.

XR devices can include sensors configured to detect/measure an action (e.g., movement) of a user in order to control one or more outputs to engage with senses (e.g., hearing, vision, tactile) of the user. For example, an XR device, worn on a head of a user, may include a sensor configured to measure movements of a head of the user and a display configured to project images to an eye of the user. The XR device may run (i.e., execute) an XR application that is configured to update the projected images according to the head movements. A new sensor for an XR device may allow for new XR applications.

### SUMMARY

In some aspects, the techniques described herein relate to an extended reality (XR) device, including: a head-worn body; at least one quantum sensor integrated in the head-worn body; and a processor configured by software instructions to execute a recognition algorithm that includes: receiving at least one brain-activity signal from the at least one quantum sensor; recognizing a thought, feeling, or brain condition from the at least one brain-activity signal; and outputting a recognition signal to control an XR application executing on the XR device.

In some aspects, the techniques described herein relate to a XR device, wherein: the head-worn body is part of a virtual-reality (VR) headset.

In some aspects, the techniques described herein relate to a XR device, wherein: the head-worn body is part of an augment-reality (AR) headset.

In some aspects, the techniques described herein relate to a XR device, wherein: the AR headset is AR glasses.

In some aspects, the techniques described herein relate to a XR device, wherein: the at least one quantum sensor is an optically pumped magnetometer (OPM).

In some aspects, the techniques described herein relate to a XR device, wherein: the optically pumped magnetometer is a nitrogen-vacancy (NV) magnetometer.

In some aspects, the techniques described herein relate to a XR device, wherein: the at least one brain-activity signal is a magnetoencephalography (MEG) signal.

In some aspects, the techniques described herein relate to a XR device, wherein: the recognition algorithm includes a neural network.

In some aspects, the techniques described herein relate to a XR device, wherein: the thought corresponds to a movement and triggers a corresponding movement of a virtual avatar in the XR application.

In some aspects, the techniques described herein relate to a XR device, wherein: the feeling corresponds to enjoyment and triggers a corresponding response by the XR application.

In some aspects, the techniques described herein relate to a XR device, wherein: the corresponding response is a recommendation of content.

In some aspects, the techniques described herein relate to a XR device, wherein: the corresponding response is a change in a user interface.

In some aspects, the techniques described herein relate to a XR device, wherein: the brain condition corresponds to a size of a brain of a user wearing the head-worn body and triggers a corresponding age verification by the XR application.

In some aspects, the techniques described herein relate to a method for brain-activity actuated extended reality (XR), the method including: positioning an XR device on a head of a user, the XR device including a plurality of quantum sensors; receiving a plurality of brain-activity signals from the plurality of quantum sensors; recognizing a thought, a feeling, or a brain condition based on the plurality of brain-activity signals; and updating an XR application executing on the XR device according to the thought, the feeling, or the brain condition.

In some aspects, the techniques described herein relate to a method, further including: training a computer model with brain-activity signals received during a training procedure to obtain a trained computer model; and using the trained computer model to recognize the thought, the feeling, or the brain condition based on the plurality of brain-activity signals.

In some aspects, the techniques described herein relate to a method, wherein receiving the plurality of brain-activity signals from the plurality of quantum sensors includes: receiving ambient magnetic information from a magnetic sensor of the XR device; and removing the ambient magnetic information from the plurality of brain-activity signals from the plurality of quantum sensors.

In some aspects, the techniques described herein relate to a method, wherein updating the XR application executing on the XR device according to the thought, the feeling, or the brain condition includes: moving a virtual avatar in the XR application.

In some aspects, the techniques described herein relate to a method, wherein updating the XR application executing on the XR device according to the thought, the feeling, or the brain condition includes: recommending content for the XR application.

In some aspects, the techniques described herein relate to a method, wherein updating the XR application executing on the XR device according to the thought, the feeling, or the brain condition includes: verifying an age of the user for the XR application.

In some aspects, the techniques described herein relate to augmented reality (AR) glasses including: a plurality of quantum sensors disposed on at least one of a left earpiece or a right earpiece of the AR glasses, the plurality of quantum sensors configured to measure magnetoencephalography (MEG) signals from portions of a brain of a user adjacent to each quantum sensor when the AR glasses are worn by the user; a camera configured to record a movement of the user; and a processor configured by software instructions to: analyze the movement of the user and the MEG signals using a machine-learning recognition algorithm to obtain results; and control an AR application running on the AR glasses based on the results.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 illustrates a quantum sensor according to a possible implementation of the present disclosure.

FIG. 2 illustrates possible magnetoencephalography signals from a set of quantum sensors.

FIG. 3 illustrates a perspective view of an AR device including a plurality of quantum sensors according to a possible implementation of the present disclosure.

FIG. 4 illustrates a perspective view of a VR device including a plurality of quantum sensors according to a possible implementation of the present disclosure.

FIG. 5 is a block diagram of an XR device according to a possible implementation of the present disclosure.

FIG. 6 illustrates a block diagram illustrating a function of a brain-activity actuated XR device according to a possible implementation of the present disclosure.

FIG. 7 illustrates a computer model according to a possible implementation of the present disclosure.

FIG. 8 illustrates a flowchart of a method for brain-activity actuated extended reality according to a possible implementation of the present disclosure.

The components in the drawings are not necessarily to scale relative to each other. Like reference numerals designate corresponding parts throughout the several views.

### DETAILED DESCRIPTION

The present disclosure describes an XR device that includes a quantum sensor configured to detect/measure brain-activity signals from a brain of a user. The brain-activity signals may be correlated with a brain activity, such as a thought, a feeling, and/or a condition of the brain (i.e., brain condition). The brain activity may be processed by a recognition algorithm (e.g., in real time) to control an XR application running of the XR device. The disclosed technology and methods may have the technical effect of providing a more efficient and/or enhanced control of an XR application and may allow for new XR applications.

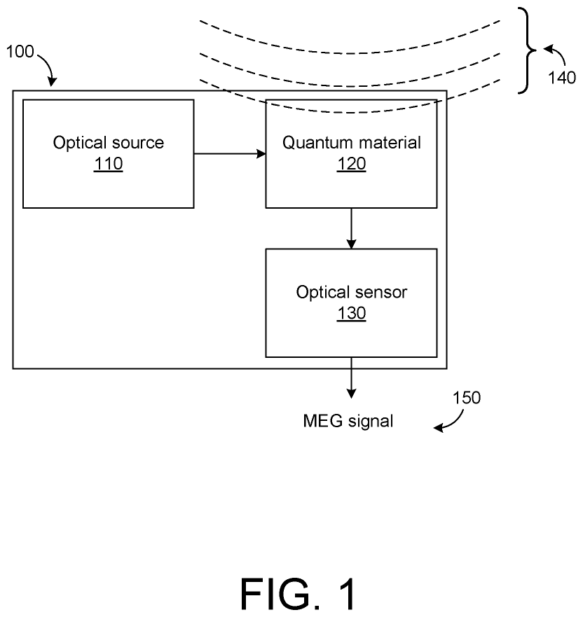

FIG. 1 illustrates a quantum sensor according to a possible implementation of the present disclosure. The quantum sensor 100 includes an optical source 110 configured to generate a beam of light at a particular wavelength. The light from the optical source 110 may be directed to a quantum material. The quantum material includes particles, each having a spin that imparts a magnetic dipole moment to the material that can interact with the light from the optical source according to quantum mechanics. For example, the interaction may cause quantum level changes (e.g., absorption) that cause the quantum material 120 to fluoresce, and the resulting fluorescent light may be received by an optical sensor 130 to provide information about the dipole moment of the material. A magnetic field 140 can alter the dipole moment of the material thereby changing a quality (e.g., wavelength) of the fluorescent light sensed by the optical sensor 130. As a result, the optical sensor may be configured to output an electrical signal that corresponds to the magnetic field 140.

The quantum sensor 100 may be further distinguished by the quantum material 120 used. Types of quantum sensors can include an optically pumped magnetometer (OPM), which uses multiple spins in a vapor, and/or a nitrogen-vacancy (NV) magnetometer, which uses a single spin isolated in a diamond. The OPM may have a higher sensitivity due to multiple spin interactions with the magnetic field, while the NV magnetometry may have higher resolution due to the single spin interaction with the magnetic field. These types of quantum sensors may be configured to detect magnetic fields at a level (e.g., >1 pico-Tesla (pT)) corresponding to brain activity.

Brain activity causes electrical interaction between neurons that can generate magnetic fields at very low levels (e.g., 100 femto-Tesla (ff)). Groups of neurons may operate similarly to produce magnetic fields in localized areas (e.g., 1 mm2) of the brain that reach the magnetic field levels detectable by the quantum sensor. The sensitivity of the quantum sensor may correspond to a range between brain neurons in a sensed area and the quantum sensor. The sensitivity of the quantum sensor may further correspond to an alignment of the quantum material (i.e., the spin(s)) and the magnetic field 140.

The optical source 110 may be a light source suitable of producing light at a power level and wavelength suitable for interaction with spins of the quantum material (i.e., spin resonances). Accordingly, the optical source 110 may be a laser (e.g., diode laser). The laser source may further include components to process the incident light. For example, the optical source may include a line filter to provide a fixed linewidth of incident light. The optical source may further include lenses and/or mirrors for collimating and directing the light onto the quantum material. The optical source may further include light intensity monitoring and feedback to maintain a fixed optical power incident on the quantum material 120.

The optical sensor 130 may be a solid-state optical detector (e.g., camera) that is suitable for measuring the light (e.g., fluorescent light) from the quantum material. The sensitivity of the optical sensor 130 may correspond to an exposure time. Accordingly, the optical sensor 130 may include an electronic and/or physical shutter to adjust an exposure time. The sensitivity of the optical sensor 130 may further correspond to an amount of noise in the light captured by the optical sensor during an exposure. The noise may correspond to stray light from the optical source 110. Accordingly, the optical sensor may include one or more filters to remove stray light from the light (e.g., fluorescent light) from the quantum material 120. The sensitivity of the optical sensor 130 may further correspond to an amount of light collected from the quantum material. Accordingly, the optical sensor 130 may include lenses and/or mirrors to maximize an amount of light captured from the quantum material 120. The optical sensor 130 is configured to convert the collected light to an electrical signal. The electrical signal corresponds to the magnetic field. When the magnetic field is from neurons (e.g., brain neurons) the electrical signal output from the optical sensor 130 is known as a magnetoencephalography signal (MEG signal 150).

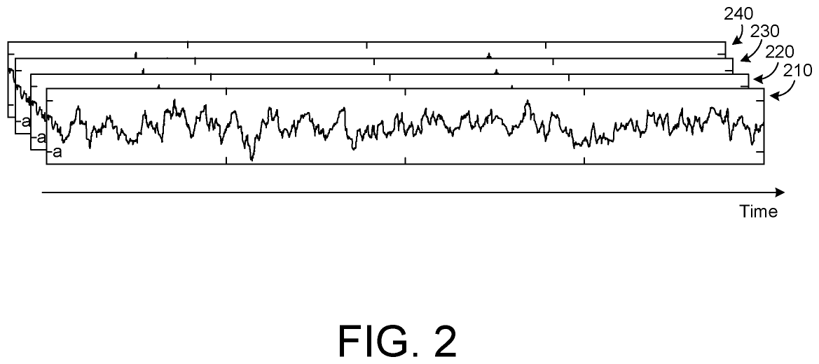

FIG. 2 illustrates a possible set of MEG signals from a set of quantum sensors. Each MEG signal in the set is a voltage/current signal having an amplitude that corresponds to the magnetic field 140 measured by a corresponding quantum sensor, and the variation of each MEG signal over time may provide information about neural activity (e.g., brain activity) in an area proximate (e.g., adjacent) to the corresponding quantum sensor. As shown as an example only, a set of quantum sensors can include a first quantum sensor configured to output a first MEG signal 210, a second quantum sensor configured to output a second MEG signal 220, a third quantum sensor configured to output a third MEG signal 230, and a fourth quantum sensor configured to output a fourth MEG signal 240. The first, second, third, and fourth quantum sensors in the set may be placed at positions proximate (<5 mm) to a skull of a user to measure brain activity at the positions. For example, the positions may be in one area of a skull (e.g., left temple) or may be distributed over multiple areas of the skull. The meg signals may be analyzed individually or collectively to determine the likelihood that they represent neural activity corresponding to a thought (e.g., intention), a feeling (e.g., emotion), and/or a brain condition (e.g., brain size).

The number of quantum sensors and their placement may be determined based on an application. A number of quantum sensors in an area may correspond to a sensitivity and/or accuracy of the measurement for that area. For example, in brain activity applications, areas of the skull likely to produce MEG signals corresponding to a particular brain activity may include a larger number of quantum sensors than other areas of the skull. The maximum number of quantum sensors in a particular area may be determined by a size of each quantum sensor. Quantum sensors may have a size that is small compared to a body of an XR device. Accordingly, multiple quantum sensors may be integrated within a body of an XR device.

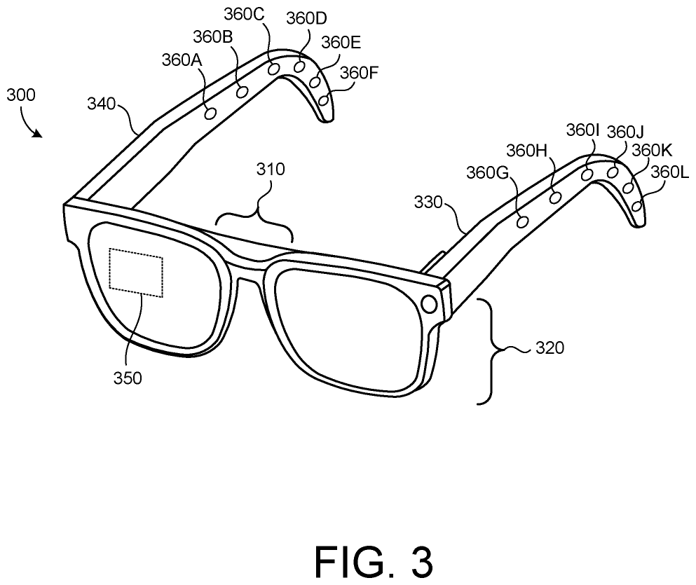

FIG. 3 is a perspective view of an XR device including a plurality of quantum sensors according to a first possible implementation of the present disclosure. As shown, the XR device is AR glasses. The AR glasses 300 are configured to be worn on the head of a user. Accordingly, the AR glasses include a body having a bridge portion 310 for support on the nose of a user and a frame portion 320 that supports and positions lenses in front of eyes of a user. The body further include a left earpiece portion 330 and a right earpiece portion 340 configured to run along temples of a user and hang on ears of a user.

The body of the AR glasses 300 may be configured to include (e.g., contain) components and circuitry to carry out augmented reality functions. Accordingly, the AR glasses 300 may include a camera configured to sense an environment of the user, a heads-up display 350 configured to display images/text/graphics to a user, and an inertial measurement unit (IMU) (e.g., accelerometers, galvanometer) configured to sense movements of a user. As shown in FIG. 3, the AR glasses 300 may be further configured to include a plurality of quantum sensors. The quantum sensors may be contained in the left earpiece portion 330 and the right earpiece portion 340. For example, quantum sensors 360A-L may be located on the left/right earpiece portions so that some of the quantum sensors are proximate to the left/right ears of a user. The quantum sensors can be configured to measure MEG signals from portions of the brain that are proximate to each quantum sensor when the AR glasses are worn by a user. The AR glasses may further include a processor that is configured to receive input from the quantum sensors and control an AR application running on the AR glasses based on a machine-learning analysis of the MEG signals. The AR glasses may be further configured to analyze a movement of the user (e.g., using the data from the camera and/or the IMU) and to modify the results of the analysis based on this movement. For example, the analysis may be configured to ignore MEG signals acquired from the quantum sensors while the user is in motion. This may help mitigate magnetic field noise in the MEG signals caused by moving the quantum sensors in the earth's magnetic field.

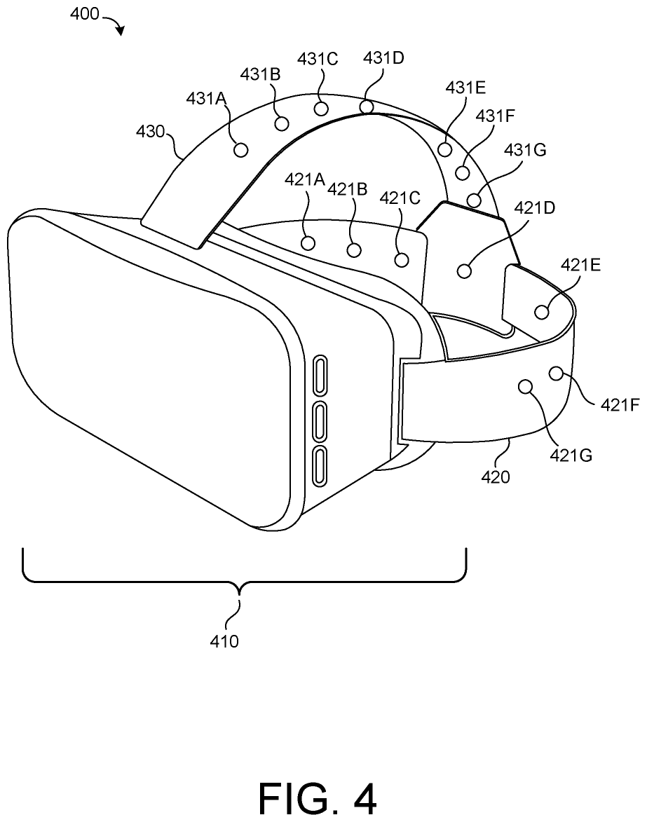

FIG. 4 illustrates a perspective view of a VR device including a plurality of quantum sensors according to a possible implementation of the present disclosure. The VR device 400 (i.e., VR headset) is a head-mounted device that provides virtual reality for the wearer. The VR device may include a stereoscopic head mounted display 410 configured to provide three-dimensional (3D) images to a user. The VR device 400 may further include motion sensors (gyroscopes, accelerometers, magnetometers, structured light, etc.), such as an IMU. The VR device may further include a side head strap 420 and a top head strap 430. The side head strap 420 can include a first set of quantum sensors 421A-G, while the top head strap 430 may include a second set of quantum sensors 431A-G. The quantum sensors may each sense brain activity in an area of the quantum sensor. Accordingly, the quantum sensors may be distributed around the head (e.g., proximate to the ears) to gather MEG signals from various areas of the brain of a user wearing the VR device.

The VR device implementation shown in FIG. 4 is presented to help understanding. The implementation is not intended to limit the present disclosure because variations may exist. For example, the number and position of the head straps and quantum sensors may vary based on brain activity and the application.

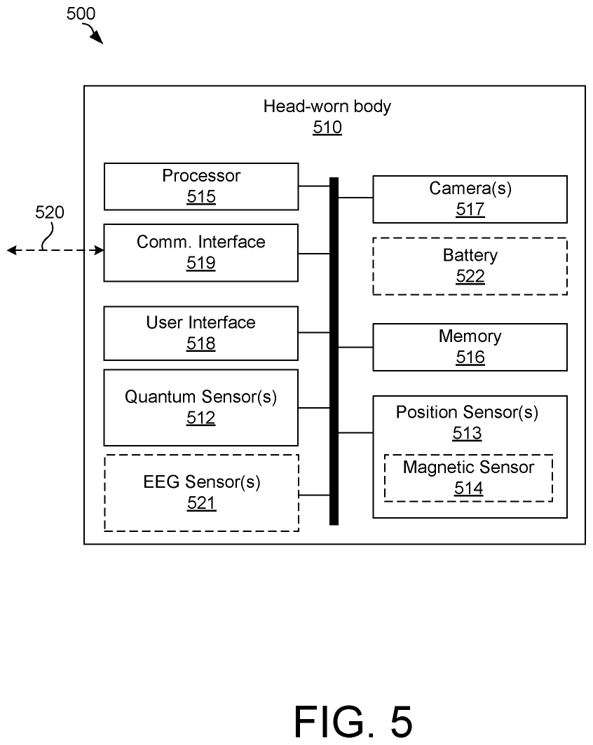

FIG. 5 is a block diagram of an XR device according to a possible implementation of the present disclosure. The XR device 500 can include a head-worn body 510. The head-worn body 510 can be part of a VR headset or an AR headset and is configured to support and include (e.g., contain) the components and electronics necessary to enable a VR or AR experience for a user wearing the head-worn body 510.

The XR device 500 may include quantum sensors 512 (e.g., optically pumped magnetometers, nitrogen-vacancy magnetometers) integrated with the head-worn body that are configured to generate brain-activity signals (e.g., MEG signals) based on magnetic fields in local areas of a brain of a user. The head-worn body 510 may position and align the quantum sensors differently to maximize coupling between each quantum sensor and a corresponding local magnetic field generated by the brain of a user.

The XR device 500 may further include one or more (e.g., a plurality of) position sensors. For example, the position sensors may be part of an inertial measurement unit (IMU) that can be configured to detect movement. In particular, the IMU can be configured to track a relative position of the head-worn body. In a possible implementation, the position sensors 513 further include a magnetic sensor 514 configured to sense ambient magnetic fields. For example, the magnetic sensor 514 may be configured to measure a magnetic field of the Earth.

The XR device 500 may further include a processor 515. The processor may be configured by software instructions. For example, the software instructions may be part of a computer program (e.g., application). The software instructions may be stored to and recalled from a non-transitory computer readable medium (i.e., memory 516) included with the XR device. The processor 515 may be configured by the software instructions to run a recognition algorithm. The algorithm may include receiving at least one brain-activity signal (e.g., MEG signal) from at least one quantum sensor and recognizing a thought, feeling, and/or brain condition from the at least one brain-activity signal. Upon recognition, the recognition algorithm can output a recognition signal to control an XR application (e.g., AR application, VR application) also running on the processor of the XR device 500.

The XR device 500 may further include a battery 522 for power and one or more cameras 517 for sensing a user and/or an environment of the user. The XR device 500 may further include a user interface 518. The user interface 518 may include a display (e.g., stereoscopic display, heads-up display) for presenting visual information (e.g., images, video, text, graphics) to a user wearing the head-worn body. The XR device may further include a communication interface 519 to enable to the XR device 500 to exchange information with another device and/or a network of other devices via a wired and/or wireless communication link 520.

In a possible implementation the XR device 500 can further include one or more electroencephalography (EEG) sensors 521 configured to acquire brain signals that result in electric field changes in local areas on a head of a user. Because the EEG signals are based on electric fields generated by the brain, they may be less susceptible to magnetic noise (e.g., from the Earth's magnetic field).

The XR device with quantum sensors can sense the signals from the brain to control and/or otherwise alter the function of the XR (i.e., AR or VR) experience for a user. Accordingly, the XR device with quantum sensors may be referred to as a brain-activity actuated XR device.

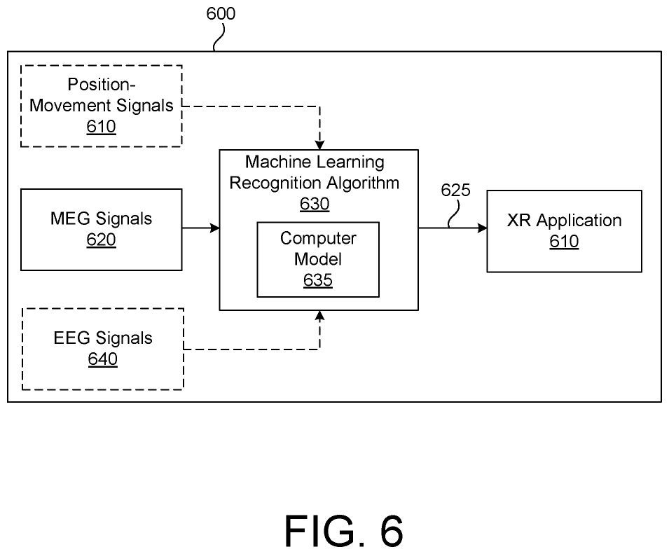

FIG. 6 is a block diagram illustrating a function of a brain-activity actuated XR device according to a possible implementation of the present disclosure. The brain-activity actuated device is configured to run an XR application 610. The XR application may receive and respond to conventional sensory inputs, such as audio and/or visual inputs (not shown). In a brain-activity actuated XR device 600, the XR application may additionally, or alternatively, receive and respond to a recognition signal 625 (or recognition signals) corresponding to a recognized brain activity and/or condition. In other words, the XR application 610 can be controlled by the recognition signal, which can represent a detection of a particular brain activity/condition or a likelihood (e.g., probability) that the particular brain activity/condition has occurred. The particular brain activity/condition may be one of a plurality of possible brain activities/conditions. In a possible implementation, probabilities for each of the possible brain activities/conditions can be included in the recognition signal so multiple activities/conditions may be simultaneously detected.

The brain-activity actuated XR device 600 may include a recognition algorithm 630 configured to recognize a brain activity correspond to a thought, feeling, and/or brain condition. The recognition algorithm may be a machine learning algorithm that can adapt its sensitivity for detection by adapting a computer model 635. The computer model 635 may be trained using supervised and/or non-supervised training. For example, a computer model 635 may be trained with brain-activity signals (i.e., MEG signals, MEG data) received during a training procedure to obtain a trained computer model. The trained computer model can then be used to recognize the thought, feeling, and/or brain condition of brain-activity signals acquired after the training procedure. In some implementations, the computer model may be updated periodically or continually based on MEG signals received during operation. These updates may help the computer model adapt to a particular user and/or environmental condition.

In operation the recognition algorithm 630 may receive MEG signals (e.g., in real time). The MEG signals from the quantum sensors may be applied to a computer model to recognize a thought, feeling and/or brain condition. In a possible implementation the recognition algorithm can be configured to receive EEG signals 640. The EEG signals may be used by the recognition algorithm 630 to aid detection (e.g., by reducing noise). The EEG signals 640 are not affected by the earth's magnetic field, and/or by head movement. Accordingly, the recognition algorithm can be configured to use the EEG signals (i.e., EEG data) to determine an effect of the earth's magnetic field (e.g., while the user moves). The recognition algorithm may further receive position/movement signals (i.e., position/movement data). For example, noise in the MEG signals 620 generated by movement can be mitigating by adapting (e.g., calibrating, blanking) the inputs to the recognition algorithm in response to the movement.

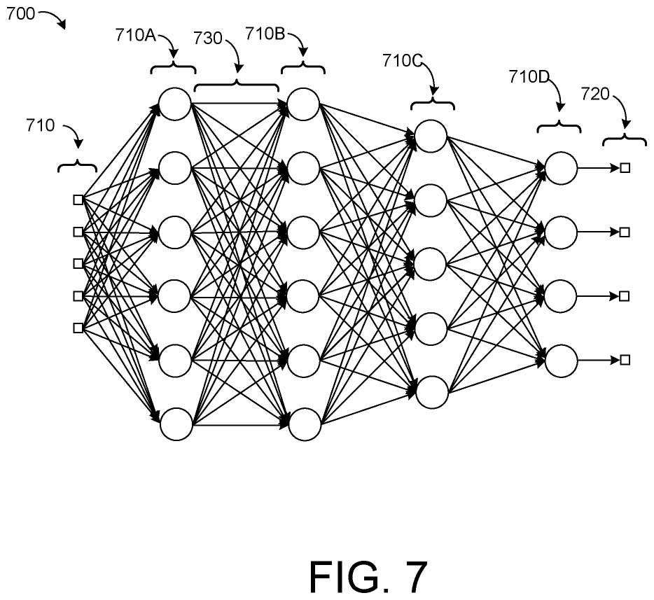

FIG. 7 illustrates a computer model according to a possible implementation of the present disclosure. The computer model 700 is configured to produce a particular output, or outputs, when a particular brain activity signal, and/or signals, are detected. As shown, the computer model may be implemented as a neural network. The neural network includes a set of computational processes for receiving a set of inputs 710 (e.g., brain-activity signals) and returning a set of outputs 720 (i.e., recognition signals). In a possible implementation, each o the outputs 720 represents a possible recognition result (e.g., a particular thought, feeling, and/or condition). In this implementation, the output with the highest value can represent the recognition result that is most likely to correspond to the inputs 710. The neural network can include layers 710A, 710B, 710C, 710D made up of neurons (e.g., represented as circles). As an analog to a biological neuron, each neuron has a value correspond to the neuron's activity (i.e., activation value). The activation value can be, for example, a value between 0 and 1 or a value between −1 and +1. The value for each neuron (i.e., node) is determined by a collection of synapses 730 (i.e., arrows) that couple each neuron to other neurons in a previous layer. The value for a given neuron is related to an accumulated, weighted sum of all neurons in a previous layer. In other words, the value of each neuron in a first layer is multiplied by a corresponding synapse weight and these values are summed together to help compute the activation value of a neuron in a second layer. Additionally, a bias may be added to the sum to help adjust an overall activity of a neuron. Further, the sum including the bias may be applied to an activation function, which maps the sum to a range (e.g., zero to 1). Possible activation functions may include (but are not limited to) rectified linear unit (ReLu), sigmoid, or hyperbolic tangent (Tan H).

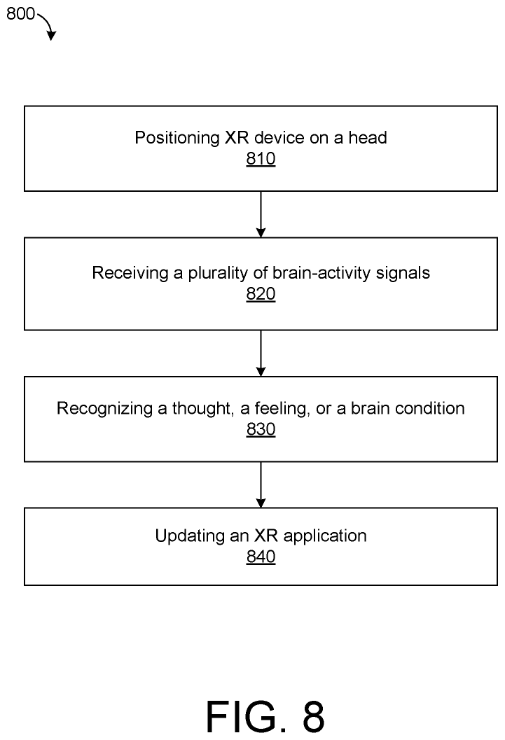

FIG. 8 illustrates a flowchart of a method for brain-activity actuated extended reality according to a possible implementation of the present disclosure. The method 800 includes positioning 810 an XR device having a plurality of quantum sensors on a head of a user so that the quantum sensors are proximate to (e.g., in contact with) a scalp of the user. The method further includes, receiving 820 a plurality of brain-activity signals from the plurality of quantum sensors and recognizing 830 a thought, feeling, and/or brain condition based on the brain-activity signals. The method further includes updating 840 an XR application based on the recognition. The updating can include controlling and/or adjusting the XR application. One or more of the steps of the method shown in FIG. 8 may be implemented as a computer program product tangibly embodied on a non-transitory computer-readable medium.

A brain-activity actuated XR device may enable a variety of functions in an XR application. Below is a non-exhaustive list of XR applications, which could be implemented with the disclosed techniques.

A first possible XR application includes controlling a virtual avatar in a virtual reality environment. Instead of using special controls, a large room, and multiple cameras to control a movement through a virtual space. the disclosed brain-activity actuated VR headset may allow the user to control the movement through the virtual space by sensing and recognizing brain-activity signals associated with intending to (i.e., thinking about the) move.

A second possible XR application includes recognizing speech (e.g., speech to text). For example, brain-activity signals associated with forming speech may be used in speech recognition. Accordingly, a user may speak quietly or silently without loss of speech recognition. This form of speech recognition (i.e., computer “lip reading”) may be useful in noisy environments or in environments where silence is important.

A third possible XR application includes adjusting content based on a recognized emotion. For example, a user's brain-activity may be recognized as an emotion (or emotions). The emotion (e.g., enjoyment) may relate to content viewed on an XR device or may be related to a user's state of mind in general. In either case, recognized emotions can be used by the XR application for recommendations (e.g., ads, music, games, videos, etc.). Additionally, or alternatively, a user interface (UI), such as a background and/or background music, of an XR application may be changed according to a recognized emotion.

A fourth possible XR application includes controlling use of an XR application based on a recognized age of the user. For example, a user's brain-activity may correspond to a size of a brain, and a user's age may correspond to the size of the brain. Accordingly, a user's brain-activity may be recognized and used to predict an age (or age-range) of a user. The recognized age can be used by the XR application to control (e.g., restrict) access or otherwise control (e.g., change) content (i.e., automatic age verification).

A fifth possible XR application includes controlling an XR application based on a recognized facial expression of the user. For example, a user's brain-activity may correspond to a facial expression. The facial expression may be recognized and used by the XR application. For example, an avatar may be made to have a matching facial expression and/or respond to the user's recognized facial expression.

A sixth possible XR application includes responding to a recognized event of epilepsy of the user. For example, a user's brain-activity may be used to predict, and/or respond to, a recognized event of epilepsy (e.g., seizure) by warning the user and/or to trigger an automated call for help.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Some implementations may be implemented using various semiconductor processing and/or packaging techniques. Some implementations may be implemented using various types of semiconductor processing techniques associated with semiconductor substrates including, but not limited to, for example, Silicon (Si), Gallium Arsenide (GaAs), Gallium Nitride (GaN), Silicon Carbide (SiC) and/or so forth.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1. An extended reality (XR) device, comprising:
a head-worn body;
at least one quantum sensor integrated in the head-worn body; and
a processor configured by software instructions to execute a recognition algorithm that includes:
receiving at least one brain-activity signal from the at least one quantum sensor;
recognizing a thought, feeling, or brain condition from the at least one brain-activity signal; and
outputting a recognition signal to control an XR application executing on the XR device.

2. The XR device according to claim 1, wherein:
the head-worn body is part of a virtual-reality (VR) headset.

3. The XR device according to claim 1, wherein:
the head-worn body is part of an augment-reality (AR) headset.

4. The XR device according to claim 3, wherein:
the AR headset is AR glasses.

5. The XR device according to claim 1, wherein:
the at least one quantum sensor is an optically pumped magnetometer (OPM).

6. The XR device according to claim 5, wherein:
the optically pumped magnetometer is a nitrogen-vacancy (NV) magnetometer.

7. The XR device according to claim 1, wherein:
the at least one brain-activity signal is a magnetoencephalography (MEG) signal.

8. The XR device according to claim 1, wherein:
the recognition algorithm includes a neural network.

9. The XR device according to claim 1, wherein:
the thought corresponds to a movement and triggers a corresponding movement of a virtual avatar in the XR application.

10. The XR device according to claim 1, wherein:
the feeling corresponds to enjoyment and triggers a corresponding response by the XR application.

11. The XR device according to claim 10, wherein:
the corresponding response is a recommendation of content.

12. The XR device according to claim 10, wherein:
the corresponding response is a change in a user interface.

13. The XR device according to claim 1, wherein:
the brain condition corresponds to a size of a brain of a user wearing the head-worn body and triggers a corresponding age verification by the XR application.

14. A method for brain-activity actuated extended reality (XR), the method comprising:
positioning an XR device on a head of a user, the XR device including a plurality of quantum sensors;
receiving a plurality of brain-activity signals from the plurality of quantum sensors;
recognizing a thought, a feeling, or a brain condition based on the plurality of brain-activity signals; and
updating an XR application executing on the XR device according to the thought, the feeling, or the brain condition.

15. The method according to claim 14, further comprising:
training a computer model with brain-activity signals received during a training procedure to obtain a trained computer model; and
using the trained computer model to recognize the thought, the feeling, or the brain condition based on the plurality of brain-activity signals.

16. The method according to claim 14, wherein receiving the plurality of brain-activity signals from the plurality of quantum sensors includes:
receiving ambient magnetic information from a magnetic sensor of the XR device; and
removing the ambient magnetic information from the plurality of brain-activity signals from the plurality of quantum sensors.

17. The method according to claim 14, wherein updating the XR application executing on the XR device according to the thought, the feeling, or the brain condition includes:
moving a virtual avatar in the XR application.

18. The method according to claim 14, wherein updating the XR application executing on the XR device according to the thought, the feeling, or the brain condition includes:
recommending content for the XR application.

19. The method according to claim 14, wherein updating the XR application executing on the XR device according to the thought, the feeling, or the brain condition includes:
verifying an age of the user for the XR application.

20. Augmented reality (AR) glasses comprising:
a plurality of quantum sensors disposed on at least one of a left earpiece or a right earpiece of the AR glasses, the plurality of quantum sensors configured to measure magnetoencephalography (MEG) signals from portions of a brain of a user adjacent to each quantum sensor when the AR glasses are worn by the user;
a camera configured to record a movement of the user; and
a processor configured by software instructions to:
analyze the movement of the user and the MEG signals using a machine-learning recognition algorithm to obtain results; and
control an AR application running on the AR glasses based on the results.
